(19) United States
(12) Patent Application Publication
(10) Pub. No.: US 2007/0264857 A1
(43) Pub. Date: Nov. 15, 2007

(54) Apparatus for Irrigation Controller Expansion through Non-Removable Circuit Board Modules

(76) Inventors: Don Michael Kearby, Caddo, TX (US); John William Oliva, Ormond Beach, FL (US)

Correspondence Address: Don Michael Kearby, 5047 FM 207, Caddo, TX, 76429, US

(21) Appl. No.: 11/383,329

(22) Filed: May 15, 2006

(51) Int. Cl. H01R 13/62

(52) U.S. Cl. 439/301

(57) ABSTRACT

An apparatus for irrigation controller expansion through non-removable circuit board modules. A circuit board module with a security tab that prevents removal from a card edge connection, a security tab that breaks upon a removal attempt, preventing re-connection to a card edge connector, a non-removable circuit board module that houses a pluggable terminal strip connector and a pluggable terminal strip connector with at least one station activation circuit.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of landscape irrigation and more specifically to an apparatus for controller expansion through non-removable circuit board modules. Programmable irrigation controllers are used throughout the world as operators to open and close solenoid valves, which allow the flow of water through piping for the purpose of applying the water in a designated site.

Modern irrigation controllers include a microprocessor utilizing separate memory or a micro-computer with memory onboard in the form of a chip. In recent years, many irrigation controllers are manufactured to allow for expansion of circuits through removable modules with at least two activation circuits per module and the ability to interchange the module across the connection board.

Module removability allows for multiple insertion and removal cycles. Both plastic and metal will fatigue when repeated insertion and removal cycles of the connections are employed. Memory degradation of the material results in poor electrical conductivity across a circuit causing a loss of operation. Accordingly, it is desirable to use a non-removable circuit board module for connection to prevent the above mentioned problem.

The most recent patent issued to Williams, et al and assigned the Toro Company features a circuit board encased in a plastic housing that is removable from the main controller housing. The Toro controller and the Toro module use a metal to metal interconnect to lock the module onto the card edge connector. The metal interconnect system holds the problems associated with metal fatique and memory loss of the material by repeated insertions and removals. The Beutler patent assigned to Hunter Industries attempts to correct the problem of the metal interconnect by means of a plastic locking mechanism. The mechanism carries with it, the same problems of fatigue and memory loss, as the plastic mechanism must be repeatedly locked and unlocked for module removal from the metal interconnect.

| | |
|---|---|
| Williams et al assigned the Toro Company | # 6,996,457 |
| Beutler et al assigned Hunter Industries | # 6,842,667 |
| Pitman/McCauley | # 5,025,361 |

### BRIEF SUMMARY OF THE INVENTION

The primary object of the invention is to provide a better method by which circuit board modules maintain electrical conductivity to a control system.

Another object of the invention is to provide a better means by which circuit board modules are wired inside a control housing.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for irrigation controller expansion through non-removable circuit board modules, comprising: a circuit board module with a security tab that prevents removal from a card edge connection, a security tab that breaks upon a removal attempt preventing re-connection to a card edge, a non-removable circuit board module that houses a pluggable terminal strip connector, and a pluggable terminal strip connector with at least one station activation circuit.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a non-removable circuit board module from the wiring end of a first embodiment of our invention.

FIG. 2 is a perspective view of a non-removable circuit board module from the interconnect end of a first embodiment of our invention.

FIG. 3 is a fragmentary perspective of a non-removal circuit board module engaged into the card edge connect with the security tab locked into the security tab receptor of a first embodiment of our invention.

FIG. 4 is an enlarged fragmentary perspective of a non-removal circuit board module with the security tab locked into the security tab receptor of a first embodiment of our invention.

FIG. 5 is an exploded view of the pluggable terminal strip connector of the second embodiment of our invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

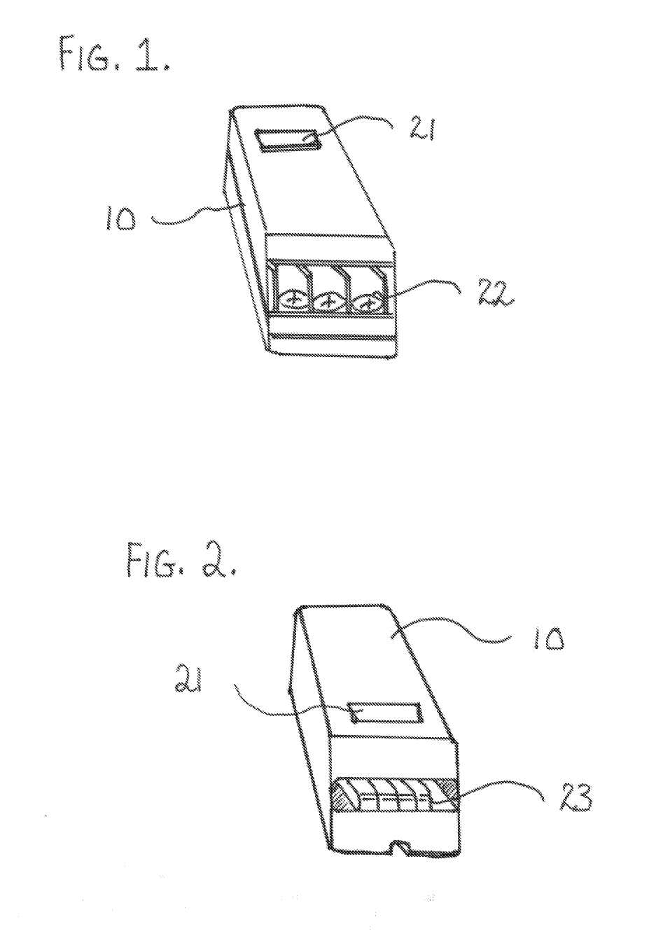

Turning first to FIG. 1 in the particular apparatus illustrated, a non-removable circuit board module 10, having a security tab 21, that is wedge-shaped and designed at an angle on the interconnect end of the non-removable circuit board module 10. A pluggable terminal strip 22, is mounted on the wiring end of the non-removable circuit board module 10.

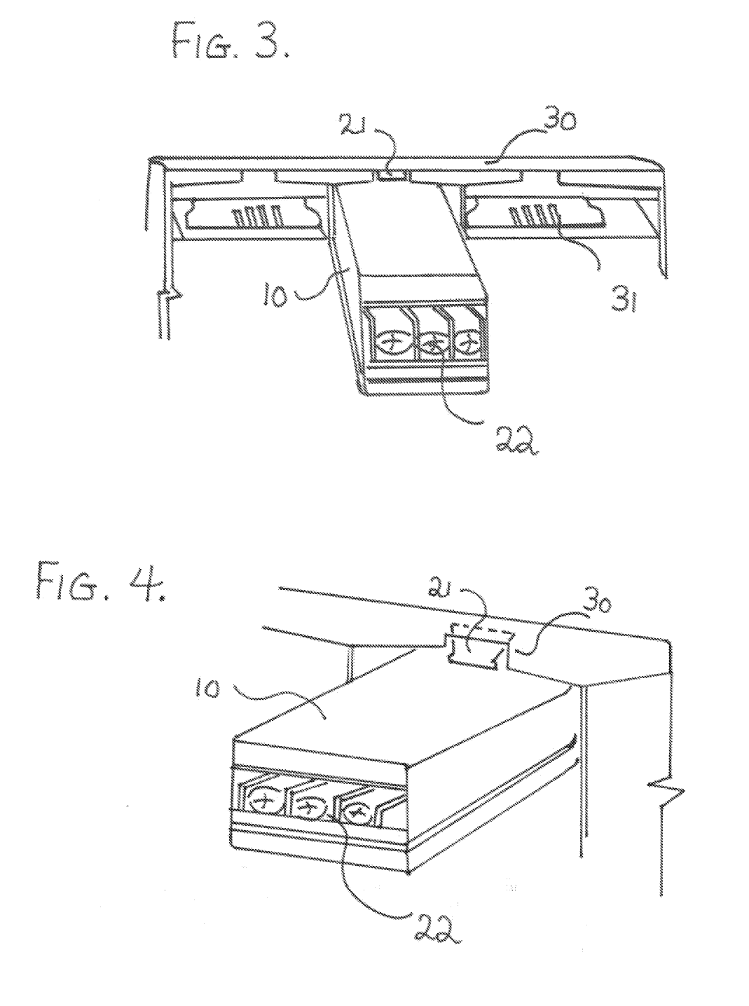

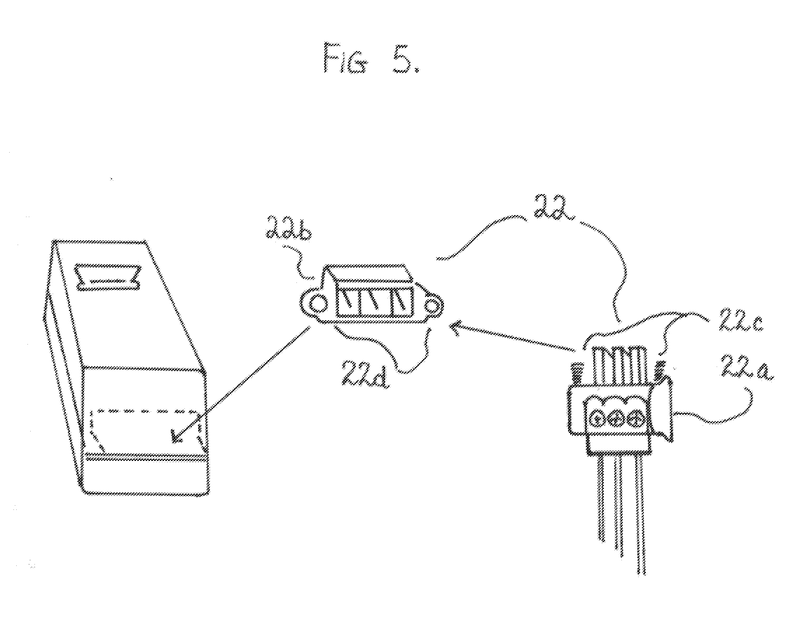

Referring now to FIG. 2 in the particular apparatus illustrated, a non-removable circuit board module 10, having a security tab 21, that is wedge-shaped and designed at an angle on the interconnect end of the non-removable circuit board module 10. A female electrical interconnect 23, is mounted on the same end as the non-removable circuit board module 10. Referring now to FIG. 3 in the particular apparatus illustrated, a non-removable circuit board module 10, slidably engaged to a card edge connector 31. Once the non-removable circuit board module 10, is fully engaged into the card edge connector 31, the security tab 21, engages the security tab receptor 30. The security tab 21, design angle allows the security tab 21, to slidably enter the leading edge of the security tab receptor 30. Once the security tab 21, is engaged with the security tab receptor 30, the non-removable circuit board module is locked onto the card edge connector 31, maintaining a static conductivity path. Referring now to FIG. 4 in the particular apparatus illustrated, the security tab 21, is pulled against the security tab receptor 30, in a removal attempt of the non-removable circuit board module 10. The security tab 21, angle mates against the back of the leading edge of the security tab receptor 30, not allowing for removal. If force is exerted against the security tab greater than the design force, the security tab 21, will break rendering the non-removable circuit board module 10, uninsertable to the card edge connector. A new non-removable circuit board module 10, must be used for insertion onto card edge connector 31, for purpose of maintaining static electrical conductivity. Referring now to FIG. 5, in the particular apparatus illustrated, a pluggable terminal strip 22, with a terminal strip male plug 22a, and terminal strip male plug-in screws 22c. The terminal strip female receptor 22b and the terminal strip female screw receptors 22d. The pluggable terminal strip 22, allows for wiring of the terminal strip male plug 22a, to be accomplished outside the confines of the controller housing (not illustrated). Once the terminal strip male plug 22a, is pluggably engaged to the terminal strip female receptor 22b, the terminals trip male plug-in screws are threadbly connected to the terminal strip female screw receptors 22d. The combination of thread and pluggable pins allows for static conductivity of electrical signals to the microprocessor or micro-computer.

While the invention has been described in connection with a preferred embodiment, it is intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for irrigation controller expansion through non-removable circuit board modules, comprising: a circuit board module with a security tab that prevents removal from a card edge connection a security tab that breaks upon a removal attempt preventing re-connection to a card edge a non-removable circuit board module that houses a pluggable terminal strip connector a pluggable terminal strip connector with at least one station activation circuit.
